(19) United States
(12) Patent Application Publication
(10) Pub. No.: US 2025/0179337 A1
(43) Pub. Date: Jun. 5, 2025

(54) HOT MELT ADHESIVE COMPOSITION COMPRISING A NATURALLY SOURCED WAX

(71) Applicant: Bostik SA, COLOMBES (FR)

(72) Inventors: Véronique BIZET, VENETTE (FR); Karine HOUËL, VENETTE (FR)

(21) Appl. No.: 18/845,924

(22) PCT Filed: Mar. 28, 2023
(86) PCT No.: PCT/FR2023/050440

§ 371 Date: Sep. 11, 2024

(30) Foreign Application Priority Data
Mar. 31, 2022 (FR) FR2202913

(51) Int. Cl. C09J 7/35; C09J 11/08; C09J 123/08

(52) U.S. Cl. CPC C09J 7/35; C09J 11/08; C09J 123/0807; C09J 2301/304; C09J 2301/414; C09J 2423/04; C09J 2491/00

(57) ABSTRACT

The present invention relates to a hot-melt adhesive composition comprising:
i) a copolymer polymerized by metallocene catalysis;
ii) from 2% to 50% by weight of a wax of natural origin having a drop melting point ranging from 65° C. to 105° C., relative to the total weight of said composition;
iii) a tackifying resin;
said hot-melt adhesive composition having a viscosity of less than 3000 mPa·s at 130° C.

### FIELD OF THE INVENTION

The present invention relates to a hot-melt adhesive composition comprising a wax of natural origin.

The present invention also relates to the uses of said composition.

### TECHNICAL BACKGROUND

Hot-melt adhesive products are widely used in a variety of commercial applications such as assembly or packaging, including for example the closure of boxes or cases in particular made of cardboard.

Hot-melt adhesives are typically applied to a substrate in the molten state. Most hot-melt adhesives on the market require temperatures of 170° C. or more in order to completely melt the components of said adhesives and make it possible to achieve a satisfactory viscosity for the application. However, these high temperatures increase the risks of burns and of inhalation of residual volatile compounds for the operators on the production lines. In addition, the use of high temperatures requires significant energy consumption.

Hot-melt adhesives allowing application at lower temperatures (for example less than or equal to 150° C.) have recently been developed. However, these hot-melt adhesives do not make it possible to combine good adhesion at both low and high temperatures. Yet hot-melt adhesives used for packaging such as, for example, the closure of boxes or cases in particular made of cardboard are subjected during transport and storage to various temperature ranges depending on climatic conditions, geographical areas, etc. Similarly, to be useful in the packaging field, hot-melt adhesives must be capable of ensuring good adhesive bonding of substrates such as paper, solid cardboard, corrugated cardboard, covered cardboard, varnished cardboard, film-coated cardboard, metallized cardboard, treated cardboard, coated cardboard, etc. This good level of adhesive bonding manifests in defiberization over a wide temperature range.

Lastly, there are currently few hot-melt adhesives that are made from raw materials of renewable origin. There is a growing desire to reduce the carbon footprint and produce products that are more environmentally friendly.

There is therefore a need for new hot-melt adhesives which make it possible to at least partially overcome at least one of the abovementioned drawbacks.

More particularly, there is a need for new hot-melt adhesives that are applicable at low temperature (for example less than or equal to 150° C.) while exhibiting good adhesive properties over a wide temperature range, for example from −20° C. to 60° C.

There is a need for new hot-melt adhesives that are applicable at low temperature (for example less than or equal to 150° C.) and exhibit good adhesive properties over a wide temperature range, for example from −20° C. to 60° C., and a good resistance to heat (for example 50° C. or more).

### DESCRIPTION OF THE INVENTION

The present invention relates to a hot-melt adhesive composition comprising:
i) a copolymer polymerized by metallocene catalysis;
ii) from 2% to 50% by weight of a wax of natural origin having a drop melting point ranging from 65° C. to 105° C., relative to the total weight of said composition;
iii) a tackifying resin having a softening temperature of less than or equal to 115° C. and selected from:
   a) terpene resins,
   b) partially or totally hydrogenated resins selected from:
      b-1) partially or totally hydrogenated natural-origin or modified rosins, such as, for example, the rosin extracted from pine gum, wood rosin extracted from tree roots and the dimerized or polymerized derivatives thereof;
      b-2) partially or totally hydrogenated rosin esters such as, for example, partially or totally hydrogenated glycerol esters of rosin, partially or totally hydrogenated pentaerythritol esters of rosin;
      b-3) partially or totally hydrogenated aliphatic resins;
      b-4) partially or totally hydrogenated cycloaliphatic resins;
      b-5) partially or totally hydrogenated, aromatic-modified aliphatic or cycloaliphatic resins,
   c) and mixtures thereof;
      said hot-melt adhesive composition having a viscosity of less than 3000 mPa·s at 130° C.

### Copolymer i)

For the purposes of the present invention, the term “copolymer” refers to a polymer formed by polymerization of at least two different monomers. The term “copolymer” also covers terpolymers which contain at least three different types of monomers.

The copolymer i) polymerized by metallocene catalysis may be a copolymer comprising ethylene, a copolymer comprising propylene, or mixtures thereof.

The copolymer i) polymerized by metallocene catalysis may be selected from:
copolymers comprising ethylene and at least one C3-C20 α-olefin;
copolymers comprising propylene and at least one monomer selected from ethylene and C4-C20 α-olefins;
mixtures thereof.

The mixtures may be a mixture of at least two different copolymers comprising ethylene and at least one C3-C20 α-olefin; a mixture of at least two different copolymers comprising propylene and at least one monomer selected from ethylene and C4-C20 α-olefins; a mixture of one or more copolymers comprising ethylene and at least one C3-C20 α-olefin with one or more copolymers comprising propylene and at least one monomer selected from ethylene and C4-C20 α-olefins.

The copolymers comprising ethylene and at least one C3-C20 α-olefin are preferably those comprising ethylene in a predominant proportion by mass. The expression “in a predominant proportion by mass of ethylene” is understood to mean the fact that the copolymer comprises a content by mass of ethylene greater than the content by mass of the other C3-C20 α-olefins.

The copolymers comprising propylene and at least one monomer selected from ethylene and C4-C20 α-olefins are preferably those comprising propylene in a predominant proportion by mass. The expression “in a predominant proportion by mass of propylene” is understood to mean the fact that the copolymer comprises a content by mass of propylene greater than the content by mass of the other monomers selected from ethylene and C4-C20 α-olefins.

The copolymers comprising propylene and at least one monomer selected from ethylene and C4-C20 α-olefins are preferably propylene-ethylene copolymers.

The C3-C20 α-olefins are preferably selected from C4-C10 α-olefins, and even more preferentially selected from C4-C8 α-olefins.

The C4-C20 α-olefins are preferably selected from C4-C10 α-olefins, and even more preferentially selected from C4-C8 α-olefins.

Preferably, the copolymer i) is selected from copolymers comprising ethylene and at least one C3-C20 α-olefin.

The content by mass of ethylene in said copolymer i) may range from 50% to 99%, preferably from 50% to 80% and even more preferentially from 50% to 70% by weight relative to the total weight of said copolymer i).

Although a polymer is often characterized as being “made from” such monomers or “based on” such monomers or “comprising” such monomers, and the like, it goes without saying that reference is made to the residue of said monomers and not to the non-polymerized monomers.

The above-mentioned copolymer i) is obtained by polymerizing monomers in the presence of a metallocene catalytic system. Metallocene catalysis is well known to those skilled in the art. The metallocene catalytic systems may in particular comprise a central transition metal and one or more ligands coordinated with the metal center. Examples of such systems are described, for example, in U.S. Pat. No. 9,998,469.

The copolymers can be obtained from monomers that are at least partially biobased or derived from the circular economy.

The C3-C20 α-olefins may be linear or branched. They may be selected from the group consisting of propene, butene, pentene, 3-methylbutene, hexene, 3-methylpentene, octene, norbornene, norbornadiene, 1-dodecene, 1-hexadodecene, 1-decene, 1-nonene, 1-methylnonene, trimethylheptene, 4-methylpentene, ethylpentene, 3-methylhexene, and mixtures thereof.

The C4-C20 α-olefins may be linear or branched. They may be selected from the group consisting of butene, pentene, 3-methylbutene, hexene, 3-methylpentene, octene, norbornene, norbornadiene, 1-dodecene, 1-hexadodecene, 1-decene, 1-nonene, 1-methylnonene, trimethylheptene, 4-methylpentene, ethylpentene, 3-methylhexene, and mixtures thereof.

Preferably, the C3-C20 α-olefins are selected from propene, hexene, octene and mixtures thereof.

The content by mass of C3-C20 α-olefins in said copolymer i) may be at least 20%, and preferably may range from 20% to 49% and even more preferentially from 30% to 49%, relative to the total weight of said copolymer i).

Preferably, the copolymer i) is a copolymer comprising ethylene and octene, more preferably the copolymer i) is a copolymer comprising only ethylene and octene, and in particular a copolymer comprising only ethylene and from 20% to 49% by weight of octene relative to the total weight of said copolymer.

The copolymer i) polymerized by metallocene catalysis may be functionalized or unfunctionalized.

For the purposes of the present invention, the term “functionalized polymer” is understood to mean a polymer chemically modified so as to obtain pendent functional groups in the backbone of said polymer. The functional groups may be selected from epoxies, silanes, amides, carboxylic acids, esters, anhydrides, and mixtures thereof.

Preferably, the copolymer i) polymerized by metallocene catalysis is not functionalized.

The copolymer i) polymerized by metallocene catalysis may have a melt flow index (MFI) of greater than 15 g/10 min, preferably greater than 400 g/10 min, and even more preferentially of between 800 and 1500 g/10 min.

The copolymer i) polymerized by metallocene catalysis preferably has a melt flow index of greater than 400 g/10 min, more preferentially of between 800 and 1500 g/10 min.

The melt flow index of the copolymer i) is measured at 190° C. and for a total weight of 2.16 kg, and is measured in accordance with the standard ASTM D1238.

The copolymer may have a glass transition temperature (Tg) of less than or equal to −35° C. The glass transition temperature can be measured by DSC, “Differential Scanning Calorimetry”.

The copolymer i) may be a block copolymer or a random copolymer.

The copolymer i) polymerized by metallocene catalysis may have a density ranging from 0.80 g/cm³ to 0.90 g/cm³, preferably from 0.85 to 0.90 g/cm³. The density of the copolymer i) can be measured according to the standard ASTM D792.

The copolymers i) polymerized by metallocene catalysis may be available commercially. Mention may for example be made of the Affinity™ products sold by Dow, such as for example Affinity® GA 1900 (C2/C8 copolymer) or Affinity@GA 1950 (copolymer C2/C8), the EXACT™ products sold by ExxonMobil Chemical (C2 copolymers), or the Versify™ products sold by Dow Chemicals (C3 copolymers), or also the Vistamaxx™ products sold by ExxonMobil Chemical (C3 copolymers).

The hot-melt adhesive composition may comprise from 20% to 60% by weight, preferably from 25% to 50% by weight and even more preferentially from 25% to 45% by total weight of copolymer(s) i), relative to the total weight of said composition.

### Wax of Natural Origin ii)

The hot-melt adhesive composition comprises from 2% to 50% by weight, relative to the total weight of said composition, of a wax of natural origin having a drop melting point ranging from 65° C. to 105° C.

The wax preferably has a drop melting point ranging from 70° C. to 105° C., more preferentially from 80° C. to 105° C.

The drop melting point of the wax can be measured by the drop melting point method according to the standard ASTM D127.

The wax of natural origin ii) may be selected from animal waxes and vegetable waxes, preferably from vegetable waxes.

The vegetable waxes may be selected from the group consisting of carnauba wax, rice bran wax, sugar cane wax, hydrogenated natural soybean, jojoba, castor or palm oil and mixtures thereof.

Preferably, the wax of natural origin ii) is a vegetable wax selected from carnauba wax, rice bran wax, and mixtures thereof.

The carnauba palm is an extremely common palm tree in north-eastern Brazil whose wax, on the surface of its palm leaves, has been exploited on a large scale for many years.

Carnauba wax is typically composed of 80-90% esters combining:
aliphatic (C24-C28) acids and (C30-C34) alcohols;
with the preceding acids and alcohols, (C22-C28) β-hydroxy acids and (C24-C34) diols;
(C24-C34) diols and p-methoxycinnamic acid.

Carnauba wax can be present in several grades (T1, T3 and T4): T1 being the purest form.

The wax of natural origin ii) may have an acid number ranging from 0 to 30 mg KOH/g, preferably from 2 to 15 mg KOH/g. The acid number of the wax can be measured according to the standard ASTM-1386.

The wax of natural origin i) may have a needle penetration value at 25° C. ranging from 0 to 20 dmm, preferably from 0 to 15 dmm. The needle penetration value (“needle penetration”) can be measured by the standard ASTM D1321.

The adhesive composition preferably comprises from 2% to 50%, preferentially from 4% to 45%, and even more preferentially from 4% to 30% by weight of wax(es) ii), relative to the total weight of said composition.

The waxes of natural origin are for example the Carnauba T1 wax (drop melting point 82-86° C.) sold by Norevo, the carnauba wax sold by Munzig (drop melting point: 81-89° C.), the Licocare RBW 300 wax (rice bran wax, drop melting point=91-105° C.) sold by Clariant, the Deurex X52G wax (sugar cane wax, drop melting point=78-82° C.) sold by Deurex.

Tackifying Resin iii)

The hot-melt adhesive composition comprises a tackifying resin iii) having a softening temperature of less than or equal to 115° C., said tackifying resin being selected from the group consisting of:
a) terpene resins,
b) partially or totally hydrogenated resins selected from:
   b-1) partially or totally hydrogenated natural-origin or modified rosins, such as, for example, the rosin extracted from pine gum, wood rosin extracted from tree roots and the dimerized or polymerized derivatives thereof;
   b-2) partially or totally hydrogenated rosin esters such as, for example, partially or totally hydrogenated glycerol esters of rosin, partially or totally hydrogenated pentaerythritol esters of rosin;
   b-3) partially or totally hydrogenated aliphatic resins;
   b-4) partially or totally hydrogenated cycloaliphatic resins;
   b-5) partially or totally hydrogenated, aromatic-modified aliphatic or cycloaliphatic resins,
c) and mixtures thereof.

The softening temperature (or point) is determined in accordance with the standardized test ASTM E28, the principle of which is as follows: a brass ring with a diameter of approximately 2 cm is filled with the test resin in the molten state. After cooling to ambient temperature, the ring and the solid resin are placed horizontally in a thermostatically controlled bath of glycerol or the like, the temperature of which can vary by 5° C. per minute. A steel ball with a diameter of approximately 9.5 mm is centred on the disk of solid resin. The softening temperature is—during the phase of rise in temperature of the bath at a rate of 5° C. per minute—the temperature at which the disk of resin yields by a height of 25.4 mm under the weight of the ball.

The tackifying resin iii) preferably has a softening temperature ranging from 60° C. to 115° C., more preferentially from 80° C. to 110° C., and even more preferentially from 90° C. to 110° C.

The tackifying resin iii) may have a weight-average molar mass Mw generally of between 500 daltons and 1000 daltons, preferably between 600 daltons and 900 daltons.

The weight-average molecular masses of the tackifying resins may be measured by methods that are well known to those skilled in the art, for example by size exclusion chromatography using a polystyrene-type standard.

The terpene resins a) cover in particular the resins synthesized by (co)polymerization of one or more terpene monomers such as for example α-pinene, β-pinene, D-limonene; the resins synthesized by copolymerization of one or more terpene monomers with one or more non-terpene monomers, for example selected from styrene, methylstyrene, isoprene, etc.; terpene-phenolic resins; and partially or totally hydrogenated derivatives thereof.

Resins synthesized by (co)polymerization of one or more terpene monomers are known under the name polyterpenes.

Terpene-phenolic resins (also called terpene phenols) are typically obtained by polymerization of terpene hydrocarbons and phenols, in the presence of a Friedel-Crafts catalyst.

Among the terpene resins, terpene-phenolic resins are preferred.

Among the terpene resins, mention may in particular be made of Dercolyte® M105 available from the company Dérivés Résiniques et Terpéniques or DRT (which is a polyterpene resin having a softening temperature of 105° C.), Dertophene® T105 sold by DRT (which is a terpene-phenolic resin having a softening temperature of 105° C.), Sylvalite 1105 sold by Kraton (which is a terpene-phenolic resin having a softening temperature of 105° C.), Picco® AR-85 available from the company Eastman (having a softening point of 85° C.), Picco® AR-100 also available from the company Eastman (having a softening point of 100° C.).

It should be noted that these abovementioned resins b) cover all resins optionally modified with an acid or anhydride (such as, for example, maleic acid or maleic anhydride).

The partially or totally hydrogenated aliphatic hydrocarbon resins b3) are well known to those skilled in the art. These are resins resulting from the polymerization of mixtures of unsaturated aliphatic hydrocarbons having, for example, 5 carbon atoms (which may, for example, be obtained from petroleum cuts or the like), followed by a (total or partial) hydrogenation step.

The partially or totally hydrogenated cycloaliphatic hydrocarbon resins b4) are well known to those skilled in the art. These are resins resulting from the polymerization of mixtures of unsaturated cycloaliphatic hydrocarbons having, for example, 10 carbon atoms (which may, for example, be obtained from petroleum cuts or the like), followed by a (total or partial) hydrogenation step. They can in particular be obtained from dicyclopentadiene and derivatives thereof (methyldicyclopentadiene, dimethyldicyclopentadiene, etc.). Among the cycloaliphatic hydrocarbon resins, DCPD (dicyclopentadiene) resins are particularly preferred.

The aromatic-modified aliphatic or cycloaliphatic hydrocarbon resins can be obtained from the copolymerization of aliphatic (for example C5) or cycloaliphatic olefins and aromatic (for example C9) olefins, followed by a (total or partial) hydrogenation step, the content of aliphatic or cycloaliphatic olefins being predominant relative to the aromatic olefins.

The abovementioned partially or totally hydrogenated resins b) are preferably selected from the group consisting of cycloaliphatic resins, aromatic-modified aliphatic or cycloaliphatic resins, and mixtures thereof.

Among the resins b-1), mention may for example be made of the Foral® DX resin (totally hydrogenated rosin resin) from DRT having a softening point of greater than 70° C., Foral® AX-E (totally hydrogenated rosin resin) from the company Eastman having a softening point of 80° C.

Among the resins b-2), mention may for example be made of Foral® 3085 (hydrogenated glycerol ester of rosin resin) from DRT having a softening point of 80° C., Foral® 85E (hydrogenated glycerol ester of rosin resin) from the company Eastman having a softening point of 85° C.

Among the resins b-3), Eastotac® H100W (hydrogenated C5 resin) from the company Eastman having a softening point of 100° C.

Among the resins b-4), mention may for example be made of the Escorez® 5400 resin from the company Exxon Chemicals (hydrogenated DCPD resin) having a softening point of 100° C., Sukorez® SU 100 (hydrogenated DCPD resin) from Kolon having a softening point of 105° C.

Among the resins b-5), mention may for example be made of Sukorez® SU400 (hydrogenated DCPD/C9 resin) sold by Kolon having a softening point of 100° C.

Preferably, the tackifying resin iii) is selected from terpene-phenolic resins and the partially or totally hydrogenated derivatives thereof, partially or totally hydrogenated cycloaliphatic resins, partially or totally hydrogenated aromatic-modified aliphatic or cycloaliphatic resins, and mixtures thereof, and even more preferentially from terpene-phenolic resins and the partially or totally hydrogenated derivatives thereof, partially or totally hydrogenated, optionally aromatic-modified DCPD resins.

Preferably, the tackifying resin iii) is a biobased tackifying resin.

In the context of the present invention, the term “biobased tackifying resin” is understood to mean a tackifying resin which is derived at least partly from a biomaterial.

In the context of the invention, the term “biocarbon” or “biobased carbon” is understood to mean carbon of renewable origin or of natural origin derived from a biomaterial, as indicated below. The terms “biocarbon content” and “biomaterial content” are used identically.

Biomaterial carbon is derived from the photosynthesis of plants and thus from atmospheric CO₂. The degradation (degradation is also understood to mean combustion/incineration at the end of their life) of these materials to CO₂ therefore does not contribute to global warming since there is no increase in carbon emitted into the atmosphere.

The CO₂ balance of the biomaterials is therefore improved and contributes to the reduction of the carbon footprint of the products obtained (only the energy of manufacturing is to be considered). In contrast, a material of fossil origin that degrades to CO₂ contributes to increasing the level of CO₂ and thus to global warming.

In the context of the invention, the terms “biomaterials” and “biobased materials” are used identically.

A material of renewable origin, called “biomaterial”, is an organic material in which the carbon is derived from CO₂ fixed recently (on a human timescale) by photosynthesis from the atmosphere. On land, this CO₂ is captured or fixed by plants. In the ocean, CO₂ is captured or fixed by bacteria or plankton using photosynthesis. A biomaterial (100% natural-origin carbon) has a ¹⁴C/¹²C isotope ratio of greater than 10⁻¹², typically approximately 1.2×10⁻¹², whereas a fossil material has a ratio equal to 0. This is because the ¹⁴C isotope is formed in the atmosphere and is subsequently incorporated by photosynthesis, over a time of a few decades at most. The half-life of ¹⁴C is 5730 years. Thus, materials resulting from photosynthesis, for example plants in general, necessarily have a maximum content of the ¹⁴C isotope.

The biomaterial content or biocarbon content is determined by the standards ASTM D 6866 (ASTM D 6866-06) and ASTM D 7026 (ASTM D 7026-04). The standard ASTM D 6866 is “Determining the biobased content of natural range materials using radiocarbon and isotope ratio mass spectrometry analysis” while the standard ASTM D 7026 is “Sampling and reporting of results for determination of biobased content of materials via carbon isotope analysis”. The second standard in its first paragraphs references the first standard.

The first standard describes a test for measuring the ¹⁴C/¹²C ratio of a sample and compares it with the ¹⁴C/¹²C ratio of a reference sample of 100% renewable origin, to give a relative percentage of carbon of renewable origin in the sample.

Preferably, the tackifying resin iii) has a biocarbon content of greater than or equal to 70%, even more preferentially greater than or equal to 80%.

The hot-melt adhesive composition may comprise from 30% to 60% by weight of tackifying resin(s) iii), preferably from 35% to 55% by weight and even more preferentially from 40% to 55% by weight, relative to the total weight of said composition.

According to a preferred embodiment, the hot-melt adhesive composition does not comprise any tackifying resin selected from partially or totally hydrogenated aromatic resins.

### Other Waxes iv)

The hot-melt adhesive composition may further comprise one or more additional waxes iv) different from the above-mentioned waxes of natural origin ii).

The waxes iv) may be selected from the group consisting of synthetic waxes such as, for example, Fischer-Tropsch waxes, petroleum waxes such as microcrystalline waxes and paraffins, and mixtures thereof.

The hot-melt adhesive composition may comprise a total content of additional wax(es) iv) ranging from 0% to 25%, preferably from 0% to 15%, relative to the total weight of said composition.

Preferably, the hot-melt adhesive composition comprises less than 5% by weight of polyethylene wax (PE wax), preferentially less than 3% by weight, even more preferentially less than 1% by weight, and even more advantageously less than 0.1% by weight, relative to the total weight of said composition. According to an even more preferred embodiment, the composition comprises less than 0.05% by weight of polyethylene wax, and even more preferentially said adhesive composition does not comprise any polyethylene wax.

### Additional Compounds

The hot-melt adhesive composition may also include one or more additive(s) appropriately chosen in order not to damage the properties of the adhesive. Mention may for example be made of plasticizers, oils, antioxidants, anticaking agents, pigments, (IR or UV) fluorescent agents, IR or UV absorbers, flame retardants, dyes, fillers, and mixtures thereof. These additives can be selected from those generally used in adhesive compositions.

The total content of additional compound(s) may range from 0% to 10%, preferably from 0% to 5% by weight, relative to the total weight of said composition.

Preferably, the hot-melt adhesive composition does not comprise any ethyl-vinyl acetate (EVA) copolymer.

Preferably, the hot-melt adhesive composition does not comprise any copolymers comprising styrene blocks.

Preferably, the hot-melt adhesive composition comprises less than 5% by weight of plasticizer(s), preferentially less than 2% by weight, relative to the total weight of said composition, and even more preferentially it does not comprise any plasticizer.

### Adhesive Composition

The hot-melt adhesive composition has a viscosity of less than 3000 mPa·s at 130° C., preferably of between 500 mPa·s and 2500 mPa·s, and even more preferentially between 1000 mPa·s and 2500 mPa·s.

The viscosity is measured by Brookfield viscosity according to the ASTM D3236 method. This viscosity can be measured using a Brookfield Thermosel instrument or any other suitable viscometer, using the test techniques as described in this ASTM method.

The hot-melt adhesive composition may comprise a total biomaterial content of greater than or equal to 2%, preferably greater than or equal to 9%, and even more preferentially greater than or equal to 45%, relative to the total weight of said composition. The biomaterial content is calculated as explained above for the tackifying resin.

The hot-melt adhesive composition according to the invention can be prepared by simple mixing of its components at a temperature of between 100° C. and 250° C., preferably of from 140° C. to 200° C., until a homogeneous mixture is obtained.

The required mixing techniques are well known to those skilled in the art.

The hot-melt adhesive composition may have a softening point ranging from 70° C. to 115° C., preferably from 75° C. to 105° C. The softening point is measured according to the method described for the tackifying resin above.

The hot-melt adhesive composition advantageously has a viscosity suitable for an application at low temperatures (less than or equal to 150° C., for example 130° C. or 150° C.).

The hot-melt adhesive composition advantageously also has good adhesive properties over a wide temperature range, for example from −20° C. to 60° C. The adhesive properties are advantageously good at low temperature (for example −20° C.) and at high temperatures (for example at 60° C.), compared with the hot-melt adhesive compositions on the market.

The hot-melt adhesive composition also advantageously has good resistance to heat (for example at 50° C. or more), namely good cohesion at these temperatures.

The hot-melt adhesive composition according to the invention is advantageously partly biobased, by virtue of the use of wax of natural origin, which responds to the growing interest of the industry in this type of composition intended to reduce the dependence on petroleum-based raw materials, while limiting the carbon footprint of manufacturing operations.

### Uses

The hot-melt adhesive composition of the invention can be used in a wide variety of applications, for example: packaging, the processing of paper and cardboard, binding, the making and closure of bags, nonwoven markets, and the like. This type of adhesive is particularly used for forming boxes, cases, cartons and trays, and as a sealing adhesive, including heat sealing applications.

The present invention relates to the use of the hot-melt adhesive composition as defined above for the adhesive bonding of two substrates.

The present invention relates to a process for assembling two substrates by adhesive bonding, comprising:
a first step of heating the hot-melt adhesive composition as defined above, for example to a temperature ranging from 90° C. to 160° C.,
a step of coating, on at least one of the two substrates to be assembled, of the composition obtained in the preceding step; and then
bringing the two substrates into effective contact so as to prepare an adhesive joint between the two substrates.

The substrates may be of identical or different nature.

The substrates may in particular be selected from virgin or recycled paper, virgin or recycled kraft paper, high- or low-density kraft paper, any type of cardboard and cellulosic support, composite materials, fiberboards or particle boards, and nonwovens. All of these substrates may be treated, covered or coated. The above-mentioned composite materials can include papers, kraft papers or cardboards laminated with metallized or non-metallized films, such as polyethylene, polypropylene, polyethylene terephthalate, Mylar, polyvinylidene chloride, ethylene-vinyl acetate and various other types of films, for example cellulose-based films, or the like.

The above-mentioned substrates by no means represent an exhaustive list, since a very wide variety of substrates, especially composite materials, find use in the packaging industry.

The first step of heating is carried out in particular for a sufficiently long time to make the hot-melt adhesive composition sufficiently liquid to be applied to a substrate.

In “on-demand” application systems, known as tankless systems, the hot-melt adhesive compositions are fed in the solid state (for example as granules) into a heated reservoir in which the composition is melted, and quickly applied to a substrate.

The coating step can be carried out by any methods known to those skilled in the art, such as by injection, by roller, by fiberization or spraying.

The hot-melt adhesive composition can be applied to a substrate in any shape such as for example continuous or discontinuous beads, dots, spirals, etc.

The hot-melt adhesive composition according to the invention can be used for the adhesive bonding of two substrates, which may or may not be different, for example for the making or closure of packagings, boxes, cartons, cases, bags, the assembly of tubs or trays, articles that include accessories (for example straws attached to beverages), ream packagings, cigarettes, filters, book binding.

All the embodiments described above may be combined with each other. In particular, the various abovementioned constituents of the composition, and in particular the preferred embodiments of the composition, may be combined with each other.

In the context of the invention, the term “between x and y” or “ranging from x to y” means a range in which the limits x and y are included. For example, the range “between 0% and 25%” in particular includes the values 0% and 25%.

The invention is now described in the following implementation examples, which are given purely by way of illustration and should not be interpreted as limiting the scope thereof.

### EXAMPLES

The following ingredients were used:

| Raw material | Nature | Supplier |
|---|---|---|
| Affinity ® GA 1900 | Ethylene-octene | Dow |
| | copolymer | |
| Primeva ® P28800 | EVA | Repsol |
| Dertophene ® T105 | Terpene phenolic resin | DRT |
| Sukorez ® SU400 | Hydrogenated C9 modified | Kolon |
| | DCPD | |
| Dertoline ® PLS | Rosin ester resin | DRT |
| | Non-hydrogenated | |
| Wingtack ET | Non-hydrogenated, | Cray Valley |
| | aromatic-modified C5 | |
| | aliphatic resin | |
| Regalite S1100 | Hydrogenated C9 aromatic | Eastman |
| | resin | |
| Sasolwax ® H1 | Fischer-Tropsch wax | Sasol |
| Shell GTL Sarawax ® | Fischer-Tropsch wax | Shell (distributor |
| SX80 | | Evonik) |
| Indopol H100 | Polybutene | Ineos |
| Carnauba T1 | Vegetable wax | Norevo |
| Paraffin 64-70 | Paraffin | Baker Pertrolite |
| Irganox 1010 | Antioxidant | BASF |

### Example 1: Preparation of the Compositions

The hot-melt adhesive compositions are obtained by hot-mixing the ingredients using a Heidolph overhead stirrer and a laboratory pot heater. The melting and mixing temperature is generally between 9° and 150° C.

The compositions prepared are collated in table 1 below.

### Example 2: Performance

The evaluation of the hot-melt adhesive is carried out on a 200 g/m² kraft paper liner based on virgin paper fibers (Fipago), which is not treated with any type of primer or varnish.

The reference cardboard substrates are cut to 5 cm×10 cm for the PAFT (temperature resistance) test, and 5 cm×6 cm for the adhesion performance. For each product, 5 assemblies are prepared and tested.

For the performance evaluation, the adhesive is applied using automatic equipment:

The adhesive is melted in a melting tank and then applied at 130° C. to the substrate with an automatic deposition gun in a bead equivalent to 2 g/linear meter. The adhesive is applied over the width of the substrate in a 4 mm bead equivalent to 2 g/linear meter. The second substrate is applied, opposite face, after 1 second of open time, and then pressed for 2 seconds by the machine.

The physical properties of the adhesives and their performance were measured by the following methods:

### Viscosity Measurement Method:

The viscosity is determined using a Brookfield viscometer, a Brookfield Thermosel heated sample chamber and a spindle adapted to the expected viscosity. The results are indicated in mPa-s.

### Softening Point Measurement Method:

The softening point is determined using an RB65G analyzer according to what is known as the ring-and-ball method in accordance with the ASTM E28 standardized test. The ring-and-ball method consists in determining the temperature at which a disk of the material held in a ring and loaded with a ball flows over a defined distance when heated at a prescribed rate in a beaker of glycerol or the like. The results are expressed in ° C.

### Evaluation of Heat Resistance—“PAFT” Test Method:

The peel adhesion failure temperature (or heat resistance test) is determined as follows:

The adhesive is applied at 130° C. using automatic equipment at 2 g/mL to a reference substrate (cut to 5 cm×10 cm) as explained above.

After 24 hours, all of the assemblies are placed in an oven at the initial temperature of 30° C., the upper substrates of the assemblies are held by a metal structure in the oven and a hole is made in the lower substrates in order to place a weight of 100 g.

The temperature of the oven is then incremented by 5° C./30 min until the adhesive joint gives way and the weight falls onto the detection cell. The temperature resistance value corresponds to the average value of the temperatures at which the weights fall, for all of the assemblies (5 assemblies tested per product).

### Adhesion Performance—Support Defiberization Evaluation Method:

The percentage of defiberization of the support is the percentage of fiber that covers the area of the adhesive after 2 substrates, which had previously been bonded together by the adhesive, are separated by force. The percentage of defiberization of the fibers exhibited by an adhesive composition is determined as follows:

All of the bonding assemblies are prepared (using an automatic device—5 cm×6 cm), placed for 24 h at ambient temperature, and then stored for 3 days inside climatic chambers at −20° C., 5° C., 23° C., and 60° C. (5 samples/temperature/adhesive).

After 3 days, the assemblies are separated from each other at the conditioning temperature by manually pulling on the 2 substrates.

The surface area of the adhesive composition is observed and the percentage of the surface area of the adhesive composition that is covered with fibers is determined and recorded in units of % tear of the fibers according to the following scale:

| % defiberization of the support | value |
|---|---|
| 81-100% | 5 |
| 51-80% | 4 |
| 21-50% | 3 |
| 1-20% | 2 |
| 0% | 1 |

Compositions having a % defiberization having a value of 5 are sought.

The results obtained according to the methods described above are presented in the table below:

TABLE 1
performance of the compositions

| | | Compar- | | | | | Compar- | Compar- | Compar- | Compar- |
|---|---|---|---|---|---|---|---|---|---|---|
| | | ative | | | | | ative | ative | ative | ative |
| | | example | | | | | example | example | example | example |
| | | 1 | Ex. 1 | Ex. 2 | Ex. 3 | Ex. 4 | 2 | 3 | 4 | 5 |
| Affinity GA | | 30 | 35 | 34 | 34 | 34 | 34 | | 34 | 34 |
| 1900 | | | | | | | | | | |
| Primeva | | | | | | | | 35 | | |
| P28800 | | | | | | | | | | |
| Dertophene | | | 45 | 48 | | 48 | | 45 | | |
| T105 | | | | | | | | | | |
| Sukorez | | 44 | | | 48 | | | | | |
| SU400 | | | | | | | | | | |
| Dertoline | | | | | | | 48 | | | |
| PLS | | | | | | | | | | |
| Wingtack | | | | | | | | | | 48 |
| ET | | | | | | | | | | |
| Regalite | | | | | | | | | 48 | |
| S1100 | | | | | | | | | | |
| Sasolwax | | 5 | | | | | | | | |
| H1 | | | | | | | | | | |
| Sarawax | | | | 7 | 7 | | 7 | | 7 | 7 |
| SX 80 | | | | | | | | | | |
| Carnauba | | | 19 | 10 | 10 | 10 | 10 | 19 | 10 | 10 |
| T1 | | | | | | | | | | |
| Paraffin | | 15 | | | | 7 | | | | |
| 64-70 | | | | | | | | | | |
| Elwax | | | | | | | | | | |
| LP1020P | | | | | | | | | | |
| Indopol | | 5 | | | | | | | | |
| H100 | | | | | | | | | | |
| Irganox 1010 | | 1 | 1 | 1 | 1 | 1 | 1 | 1 | 1 | 1 |
| Total | | 100 | 100 | 100 | 100 | 100 | 100 | 100 | 100 | 100 |
| Viscosity | mPa · s | 920 | 2020 | 1830 | 2120 | 1900 | 7500 | 2520 | 1680 | 1788 |
| @130° C. | | | | | | | | | | |
| Softening | ° C. | 90 | 83 | 81 | 82 | 79 | 86 | 85 | 86 | 84 |
| point-R&B | | | | | | | | | | |
| Temperature | ° C. | 35 | 55 | 54 | 58 | 55 | — | 52 | 54 | 55 |
| resistance | | | | | | | | | | |
| Adhesive | | | | | | | | | | |
| applied at | | | | | | | | | | |
| 130° C. | | | | | | | | | | |
| Adhesion | −20° C. | 3 | 4 | 4 | 4 | 4 | — | 1 | 2 | 1 |
| performance | 5° C. | 5 | 5 | 5 | 5 | 5 | — | 2 | 4 | 3 |
| Adhesive | 23° C. | 5 | 5 | 5 | 5 | 5 | — | 5 | 5 | 5 |
| applied at | 50° C. | 4 | 5 | 5 | 5 | 5 | — | 5 | 5 | 5 |
| 130° C. | 60° C. | 1 | 5 | 5 | 5 | 5 | — | 5 | 5 | 5 |
| Defiberization | | | | | | | | | | |
| of the | | | | | | | | | | |
| support | | | | | | | | | | |
| (%) | | | | | | | | | | |

Comparative example 1 is an adhesive on the market. The combination of the different raw materials allows low-temperature application but does not make it possible to achieve a good level of performance at very low temperature (−20° C.), and bonding performance at high temperatures is limited by the low temperature resistance (PAFT).

The compositions of examples 1 to 4 advantageously exhibit a good level of heat resistance (PAFT) >50° C. while retaining very good adhesive performance over a wide temperature range: from −20° C. to 60° C. (defiberization of between 4 and 5 according to the indicative table). The viscosity level also makes it possible to apply them starting from 130° C. and above, while maintaining good wettability of the support.

Comparative example 2, which comprises a non-hydrogenated rosin ester resin, does not make it possible to achieve an acceptable viscosity level for an application at 130° C. It was not possible to achieve adhesive bonding with this comparative composition which is not compatible.

Comparative example 3 uses an EVA copolymer and not a metallocene copolymer. This composition exhibits poor adhesive bonding performance at low temperatures (defiberization of 1 and 2 in value according to the reference table).

Comparative example 4 does not use a tackifying resin as defined in the invention. This example uses a hydrogenated C9 aromatic tackifying resin. This composition leads to poor performance at low temperature (defiberization of 2 in value according to the reference table at −20° C.). At 5° C., the defiberization values are lower than those obtained with the compositions of examples 1 to 4 using a composition according to the invention.

Comparative example 5 does not use a tackifying resin as defined in the invention. This example uses a non-hydrogenated aromatic-modified aliphatic tackifying resin. This composition leads to poor performance at low temperature (defiberization of 1 in value according to the table at −20° C.). At 5° C., the values are lower than those obtained with examples 1 to 4 using a composition according to the invention.

1-17. (canceled)

18. A hot-melt adhesive composition comprising:
i. a copolymer polymerized by metallocene catalysis;
ii. from 2% to 50% by weight of a wax of natural origin having a drop melting point ranging from 65° C. to 105° C., relative to the total weight of said composition;
iii. a tackifying resin having a softening temperature of less than or equal to 115° C. and selected from:
a) terpene resins,
b) partially or totally hydrogenated resins selected from:
b-1) partially or totally hydrogenated natural-origin or modified rosins;
b-2) partially or totally hydrogenated rosin esters;
b-3) partially or totally hydrogenated aliphatic resins;
b-4) partially or totally hydrogenated cycloaliphatic resins;
b-5) partially or totally hydrogenated, aromatic-modified aliphatic or cycloaliphatic resins,
c) and mixtures thereof;
said hot-melt adhesive composition having a viscosity of less than 3000 mPa·s at 130° C.

19. The composition as claimed in claim 18, characterized in that the copolymer i) polymerized by metallocene catalysis is selected from the group consisting of:
copolymers comprising ethylene and at least one C3-C20 α-olefin;
copolymers comprising propylene and at least one monomer selected from ethylene and C4-C20 α-olefins; and
mixtures thereof.

20. The composition as claimed in claim 18, characterized in that the copolymer i) is selected from copolymers comprising ethylene and at least one C3-C20 α-olefin.

21. The composition as claimed in claim 18, characterized in that the copolymer i) is a copolymer comprising ethylene and octene.

22. The composition as claimed in claim 18, characterized in that the wax of natural origin ii) has a drop melting point ranging from 70° C. to 105° C.

23. The composition as claimed in claim 18, characterized in that the wax of natural origin ii) is selected from vegetable waxes.

24. The composition as claimed in claim 18, characterized in that it comprises from 4% to 45% by weight of wax(es) ii), relative to the total weight of said composition.

25. The composition as claimed in claim 18, characterized in that the tackifying resin iii) is selected from terpene-phenolic resins and the partially or totally hydrogenated derivatives thereof, partially or totally hydrogenated cycloaliphatic resins, partially or totally hydrogenated aromatic-modified aliphatic or cycloaliphatic resins, and mixtures thereof.

26. The composition as claimed in claim 18, characterized in that it comprises from 30% to 60% by weight of tackifying resin(s) iii), relative to the total weight of said composition.

27. The composition as claimed in claim 18, characterized in that it has a viscosity of less than 3000 mPa·s at 130° C.

28. The composition as claimed in claim 18, characterized in that it comprises a total biomaterial content of greater than or equal to 2%, relative to the total weight of said composition.

29. The composition as claimed in claim 18, characterized in that it comprises less than 5% by weight of polyethylene wax, relative to the total weight of said composition.

30. The composition as claimed in claim 18, characterized in that it does not comprise any partially or totally hydrogenated aromatic C9 tackifying resin.

31. The composition as claimed in claim 18, characterized in that the copolymer i) polymerized by metallocene catalysis has a melt flow index of greater than 400 g/10 min.

32. The composition as claimed in claim 18, characterized in that it does not comprise any copolymers comprising styrene blocks.

33. The composition as claimed in claim 18, characterized in that it comprises less than 5% by weight of plasticizer(s).

34. A method of adhesive bonding of two substrates comprising applying the composition as claimed in claim 18 to at least one of the two substrates and bringing the two substrates into contact in such a way that adhesive bonding takes place.
